(19) United States
(12) Patent Application Publication
(10) Pub. No.: US 2024/0317389 A1
(43) Pub. Date: Sep. 26, 2024

(54) EDDY-CURRENT-BASED MAGNETIC BRAKING DEVICE, VEHICLE BRAKED WHEEL AND AIRCRAFT LANDING GEAR EQUIPPED WITH SUCH A WHEEL

(71) Applicant: SAFRAN LANDING SYSTEMS, VELIZY VILLACOUBLAY (FR)

(72) Inventors: Duy-Minh NGUYEN, Vélizy-Villacoublay (FR); Guillaume DURAND, Créteil (FR); Graeme KLIM, Vélizy-Villacoublay (FR)

(73) Assignee: SAFRAN LANDING SYSTEMS, VELIZY VILLACOUBLAY (FR)

(21) Appl. No.: 18/578,786

(22) PCT Filed: Jul. 13, 2022
(86) PCT No.: PCT/EP2022/069685

§ 371 Date: Jan. 12, 2024

(30) Foreign Application Priority Data
Jul. 14, 2021 (FR) 2107629

(51) Int. Cl. B64C 25/42; B60L 7/24; B60L 7/28; B60T 13/74; F16D 55/38; F16D 65/18; F16D 121/20; H02K 49/04

(52) U.S. Cl. CPC B64C 25/42; B60L 7/24; B60L 7/28; B60T 13/746; B60T 13/748; F16D 55/38; F16D 65/186; H02K 49/04; B60L 2200/10; F16D 2121/20; F16D 2200/0013; F16D 2200/0021

(57) ABSTRACT

An eddy-current-based magnetic braking device includes two external elements flanking a central element that is aligned with a same axis as the external elements and that rotates about said axis with respect to the external elements, the external elements each bearing magnets that emit a magnetic flux that engenders in the central element eddy currents. The magnets are placed so as to generate a magnetic attraction between the external elements. Friction-based braking surfaces are joined so as to rotate as one with the external elements and with the central element, respectively. The external elements are moveable with respect to the axis between a proximate position of the central element, in which position the first braking surfaces are held applied against the second braking surfaces via the magnetic attraction, and a separated position of the central element, in which position the first braking surfaces are separated from the second braking surfaces.

The present invention relates to the field of braking of vehicle wheels, such as aircraft wheels.

### BACKGROUND OF THE INVENTION

An aircraft wheel generally comprises a rim connected by a wall to a hub mounted to rotate on a wheel support shaft (axle or spindle).

Friction braking devices are known, comprising a brake disc stack which is housed in a space extending between the rim and the hub and which comprises alternating rotor discs joined so as to rotate as one with the wheel and stator discs, stationary with respect to the wheel support. The braking device also comprises hydraulic or electromechanical actuators mounted on an actuator carrier and arranged to apply a controlled braking force on the disc stack, so as to block the rotation of the wheel.

It has been proposed, in particular in document FR-A-2953196, to equip such braked wheels with an electromagnetic auxiliary brake ensuring an energy dissipation by means other than mechanical friction.

Eddy current magnetic braking devices are further known, used for the braking of vehicle wheels, and more specifically, aircraft wheels. Document W0-A-2014/029962 describes such a device comprising a rotor which is provided with one or more magnets, and which is mounted opposite an electromagnetic stator.

Document US-A-20200300310 itself also describes an eddy current magnetic braking device.

Furthermore, the magnetic braking torque by eddy current depends directly on the speed of the central element with respect to the external element such that this torque is zero when the speed is zero. It is therefore necessary to provide an additional braking means for low speeds and/or when the aircraft is parking (parking brake). This assumes that the weight of the assembly increases.

### AIM OF THE INVENTION

The invention aims, in particular, to propose an eddy current magnetic braking device, at least partially overcoming the abovementioned disadvantages.

### SUMMARY OF THE INVENTION

To this end, a landing gear is provided, comprising a strut having an end bearing a shaft on which the hub of a wheel is mounted, provided with an eddy-current-based magnetic braking device. The device comprises two external elements flanking a central element aligned on the same axis with the external elements and that rotates about said axis with respect to the external elements, the external elements having first faces facing second opposite faces of the central element and each bearing a plurality of magnets able to emit a magnetic flux via the first faces, engendering in the central element, made of electrically conductive material, eddy currents when the elements are in relative motion. The magnets being placed so as to generate a magnetic attraction between the external elements. First friction-based braking surfaces are joined so as to rotate as one to the external elements and second friction-based braking surfaces are joined so as to rotate as one to the central element and the external elements are movable with respect to the axis between a proximate position of the central element, in which the first braking surfaces are held applied against the second braking surfaces by magnetic attraction and a separated position of the central element, in which the first braking surfaces are separated from the second braking surfaces.

This arrangement makes it possible to optimise a friction-based braking which is integrated in the magnetic brake and the holding of which does not require an energy source, since it is the magnetic attraction of the magnets which will hold the braking surfaces in contact, and generate in this way, a clamping of the central element between the external elements. Naturally, the braking torque depends on the power of the magnets, but if the friction-based braking is used only as a parking brake and optionally to slow down the low-speed wheel, the attraction by the magnets will be sufficient for the parking brake.

The invention also relates to a braked wheel equipped with such a device and a landing gear equipped with such a wheel.

Other features and advantages of the invention will emerge upon reading the following description of particular and non-limiting embodiments of the invention.

### BRIEF DESCRIPTION OF THE DRAWINGS

Reference will be made to the accompanying drawings, among which:

FIG. 1 is a partial, schematic view of an aircraft equipped with landing gears according to the invention;

FIG. 2 is a perspective view of a wheel according to the invention, the wheel not having its tyre;

FIG. 3 is a partial, schematic view of this wheel, as a cross-section along the plane III of FIG. 2, showing a magnetic braking device according to a first embodiment, this braking device being equipped with an actuator according to a first embodiment;

FIG. 4 is a partial, schematic view of this wheel, as a cross-section along the plane IV of FIG. 2;

FIG. 5 is a partial, schematic view of this wheel, as a cross-section along the plane V of FIG. 2;

FIG. 6 is a perspective view of the engine ring and pinions of the transmission assemblies according to a first variant of the first embodiment of the actuator;

FIG. 7 is a view similar to that of FIG. 4 of the wheel according to this variant of an embodiment;

FIG. 8 is a view similar to that of FIG. 5 of the wheel according to this variant of an embodiment;

FIG. 9 is a partial front view of the wheel showing the pinions of the transmission assemblies according to a second variant of the first embodiment of the actuator;

FIG. 10 is a view similar to that of FIG. 4 of the wheel, the magnetic braking device being equipped with an actuator according to a second embodiment;

FIG. 11 is a view similar to that of FIG. 5 of the wheel, showing the actuator according to the second embodiment;

FIG. 12 is a partial, schematic view of a stator according to a first embodiment;

FIG. 13 is a partial, schematic view of a stator according to a second embodiment;

FIG. 14 is a partial, schematic view of a stator according to a third embodiment;

FIG. 15 is a partial, schematic view of a stator of the magnetic braking device according to the first embodiment;

FIG. 16 is a view similar to that of FIG. 3, showing a magnetic braking device according to a second embodiment.

### DETAILED DESCRIPTION OF THE INVENTION

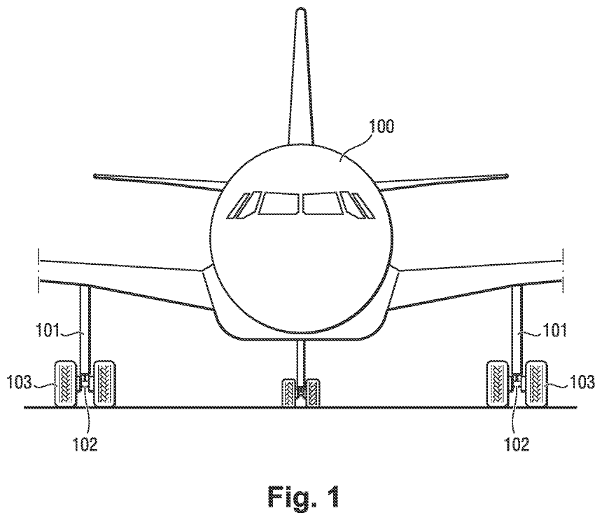

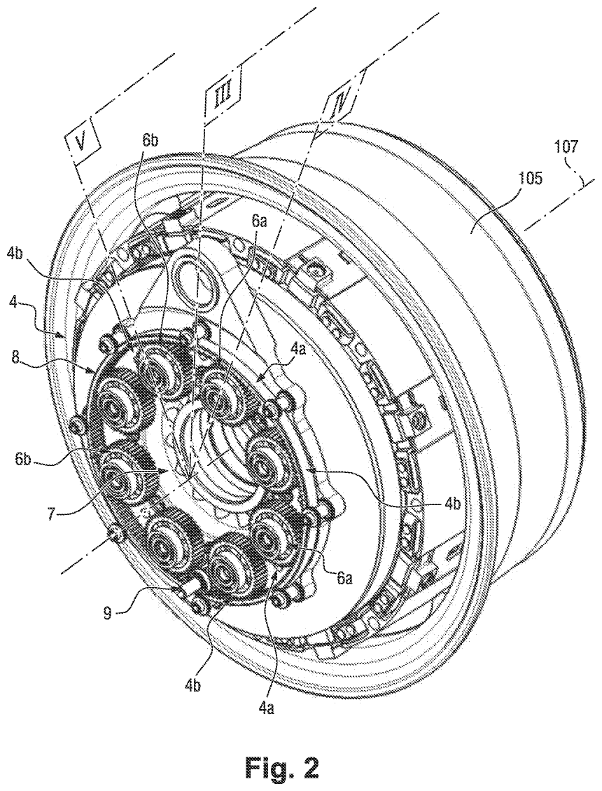

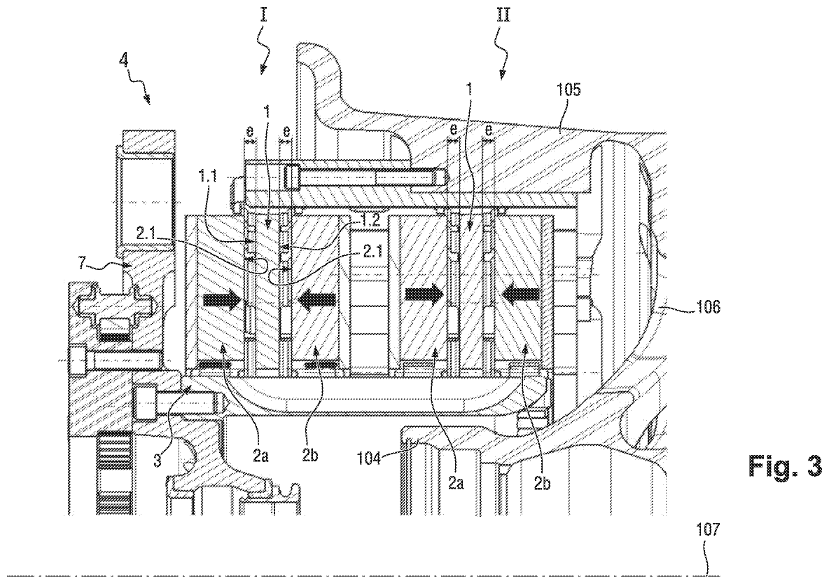

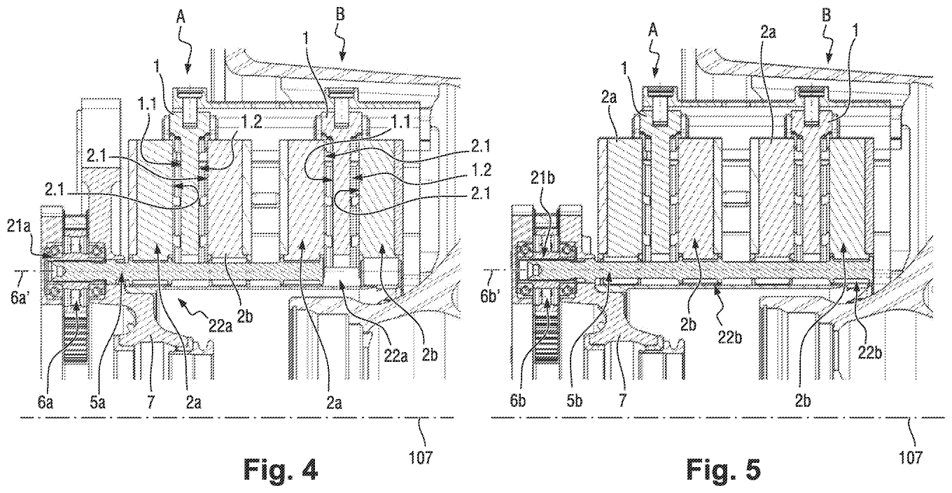

In reference to FIGS. 1 to 5, the first embodiment of the invention is described in application to an aircraft 100 comprising landing gears 101. Each landing gear 101 comprises a strut having an end provided with two coaxial shafts 102 on each of which a wheel 103 is mounted to pivot. Each wheel 103 comprises, in a manner known per se, a hub 104 mounted to pivot on the shaft 102 and a rim 105 connected to the hub 104 by a wall 106. The shafts 102 define a primary rotary axis 107 of the wheel 103.

The wheels 103 are each equipped with a magnetic braking device.

The magnetic braking device comprises elements which are movable so that they can rotate, or rotors 1, and stationary elements, or stators 2.

More specifically, in this case, the stators 2 and the rotors 1 are disc-shaped, coaxial to the wheel 103, therefore having central axes combined with the primary rotary axis 107. The stators 2 and the rotors 1 are arranged in two triplets, each forming a braking clearance I, II. Each braking clearance I, II comprises a rotor placed between two stators 2a, 2b, each having a main face 2.1 extending opposite one of the main faces 1.1, 1.2 of the rotor 1. The faces 1.1, 1.2, 2.1 are parallel to one another. In the figures, the characters a, b have been added to distinguish the stator located opposite the face 1.1 and the stator located opposite the face 1.2. Each clearance I, II therefore comprises a rotor 1, a stator 2a and a stator 2b. In the description, these characters a, b are only used when it is necessary to distinguish the stators 2 from one another.

The stators 2 are joined so as to rotate as one to the shaft 102 or to the strut of the landing gear 101, in this case by way of a twisting tube 3 (or torque tube) integral with an actuator carrier plate 7 rigidly fixed to the shaft 102, while the rotors 1 are joined so as to rotate as one to the wheel 103, in this case to the rim 105 of the wheel 103, in a manner known per se. Thus, in each clearance I, II, each rotor 1 rotates on itself about its central axis with respect to the stators 2a, 2b which flank it: during this movement of the rotor 1 in a circumferential direction, the main faces 1.1, 1.2 remain opposite the main faces 2.1, parallel to these and separated by an air gap e. The stators 2a are located opposite the face 1.1 of the rotor 1 oriented towards the actuator carrier plate 7; the stators 2b are located opposite the face 1.2 of the rotor 1 oriented opposite towards the wall of the wheel 103.

The twisting tube 3 is provided with ridges to form sliders making it possible for each of the stators 2 to slide without rotation on the twisting tube 3, such that each stator 2 is movable in an axial direction of the twisting tube 3 between a first position, in which the rotor 1 and the stator 2 are moved closer towards one another and have their main faces 1.1, 1.2, 2.1 in contact (zero air gap) and a second position, in which the rotor 1 and the stator 2 are separated from one another and have their main faces 1.1, 1.2, 2.1 separated by a predetermined air gap value (non-zero air gap).

The braking device comprises an actuator, generally referenced as 4, controllable by the pilot of the aeroplane, in a manner known per se, to move the stators 2 between the two abovementioned positions.

The actuator 4, according to the first embodiment, comprises a plurality of transmission assemblies, generally referenced as 4a to move the stators 2a and a plurality of transmission assemblies generally referenced as 4b to move the stators 2b. The transmission assemblies 4a are alternately placed with respect to the transmission assemblies 4b.

Each transmission assembly 4a comprises an operating bar 5a mounted on the twisting tube 3 to extend parallel to the primary rotary axis 107 and slide, without rotation, about said axis.

The operating bar 5a is connected by a first mechanical connecting member 21a to a pinion 6a mounted in the actuator carrier plate 7 by rollers to be stationary in translation and movable so as to rotate about a secondary rotary axis 6a′ colinear with the longitudinal axis of the operating bar 5a. The first mechanical connecting member 21a comprises a mesh made on the end of the operating bar 5a and a tapping made in the pinion 6a and receiving the end of the operating bar 5a, such that a rotation of the pinion 6a causes a translation of the operating bar 5a in one direction or in the other, in the rotary direction of the pinion 6a. The pinions 6a mesh with an internal gearing of a ring 8 which is centred on the primary rotary axis 107 and which surrounds the pinions 6a. The ring 8 is held in its centred position by rollers mounted to pivot on the actuator carrier plate 7 about axes parallel to the primary rotary axis 107 and in contact with an external perimeter of the ring 8. The ring 8 is rotated by a driving pinion 9 mounted to pivot on the actuator carrier plate 7 about an axis parallel to the primary rotary axis 107. The means for rotating the driving pinion are not represented, but can be of any type (mesh, belt, chain, rack, etc.).

The operating bar 5a is connected by a second mechanical connecting member 22a to each stator 2a. Each second mechanical connecting member 22a comprises two collars extending radially projecting from the operating bar 5a to receive between them, a portion of the internal circumference of one of the stators 2a and form abutments for driving the stators 2a between their two axial positions.

Each transmission assembly 4b comprises an operating bar 5b mounted on the twisting tube 3 to extend parallel to the primary rotary axis 107 and slide, without rotation, about said axis.

The operating bar 5b is connected by a first mechanical connecting member 21b to a pinion 6b mounted in the actuator carrier plate 7 by rollers to be stationary in translation and movable so as to rotate about a secondary rotary axis 6b′ colinear with the longitudinal axis of the operating bar 5b. The first mechanical connecting member comprises a mesh made on the end of the operating bar 5b and a tapping made in the pinion 6b and receiving the end of the operating bar 5a, such that a rotation of the pinion 6b causes a translation of the operating bar in one direction or in the other, in the rotary direction of the pinion 6b. The pinions 6b mesh with the internal gearing of the ring 8.

The operating bar 5b is connected by a second mechanical connecting member to each stator 2b. Each second mechanical connecting member comprises two collars 20b extending radially projecting from the operating bar 5b to receive between them, a portion of the internal circumference of one of the stators 2b and form abutments for driving the stators 2b between their two axial positions.

The helical connection formed between the pinions 6b and the operating bars 5b is of the direction opposite the helical connection formed between the pinions 6a and the operating bars 5a. It is therefore understood that, when the ring 8 rotates in one direction, it drives the pinions 6a, 6b in the same direction; however, the operating bars 5a move in a direction opposite the direction of movement of the operating bars 5b. A rotation of the ring 8 in a first direction therefore causes a proximation of the stators 2a with the stators 2b (the air gap e with the rotors 1 decreases) while a rotation of the ring 8 in a second direction causes an extension of the stators 2a with the stators 2b respectively (the air gap e with the rotors 1 increases).

The rotors 3 are, in this case, made of steel or cast iron, such that their faces 1.1, 1.2 can form braking surfaces, as well as will be explained below. Any other electrically conductive material able to perform this function can be used. For example, the rotors 3 can comprise a copper disc, the main faces of which are covered with a steel or cast iron layer to form the braking surfaces, which makes it possible to have a good friction coefficient with the trim, while increasing the calorie mass so as to have an efficient braking, despite the increase of temperature caused by the friction of the trim on the braking surface.

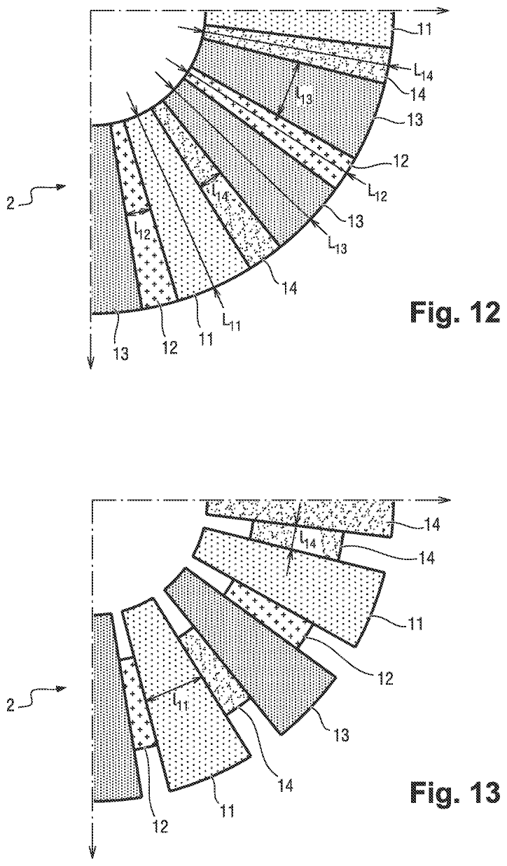

In reference to FIGS. 12, 13 and 14 also, each stator 2 of each triplet comprises a plurality of magnets able to engender eddy currents in the rotor 1 when the stator 2 is in an intermediate position between the first and second positions, and that the rotor 3 pivots facing the stator 2. There are, for example, 16 magnets, in this case, rare earth-based, and are preferably fixed to a magnetic steel support 200, even to a non-magnetic support.

The plurality of magnets comprises first magnets 11, 13 having a first magnetisation vector substantially perpendicular to the main face 2.1 and being separated in pairs by a second magnet 12, 14 having a second magnetisation vector substantially perpendicular to the first magnetisation vectors of the two first magnets 11, 13 between which the second magnet 12, 14 is located. It is reminded that the magnetisation vector indicates the direction of the magnetic field generated by a magnet and extends into the magnet from the South pole to the North pole. More specifically, the magnets 11, 12, 13, 14 have angular sector shapes, and have a length L measured in a radial direction of the stator 2 and an average width 1 measured in a locally tangential direction of the discs (i.e. perpendicularly to the direction of the length L), at half said length L. The lengths L and widths 1 are measured in directions locally parallel to the opposite surfaces (the main faces 1.1, 1.2, 2.1).

The magnets 11, 12, 13, 14 are placed according to a Halbach array, alternately in the circumferential direction of the stator 2 as follows: a magnet 11, a magnet 12, a magnet 13, a magnet 14, a magnet 11, a magnet 12, a magnet 13, a magnet 14 and so on, etc. In this case:
each magnet has its magnetisation vector which exits from the main face 2.1 (its North pole opens onto the main face 2.1),
each magnet 12 has its magnetisation vector which extends from the neighbouring magnet 11 to the neighbouring magnet 13,
each magnet 13 has its magnetisation vector which returns into the main face 2.1 (its South pole opens onto the main face 2.1),
each magnet 14 has its magnetisation vector which extends from the neighbouring magnet 11 to the neighbouring magnet 13.

It is understood that the magnets 12, 14 placed on each side of the same magnet 11 have their magnetisation vector oriented in opposite directions.

In each triplet, each magnet 11 of one of the two stators 2 faces a magnet 13 of the other of the two stators 2, and vice versa, such that all the magnets 11 face magnets 13 and are mutually attracted through the rotor 3, which improves the performance.

According to an advantageous version of the invention, the magnets 11, 12, 13, 14 have widths 111, 112, 113, 114 such that the first magnets 11, 13 are spaced apart in pairs by a first distance (equal to the width 112, 114) less than a second distance (equal to the width 111, 113) separating the second magnets 12, 14 in pairs. The best results are obtained when the width 112, 114 of the second magnets 12, 14 is around 70% of those—111, 113—of the first magnets 11, 13.

In reference to FIG. 12, the lengths L11, L12, L13, L14 of the magnets 11, 12, 13, 14 are identical to one another.

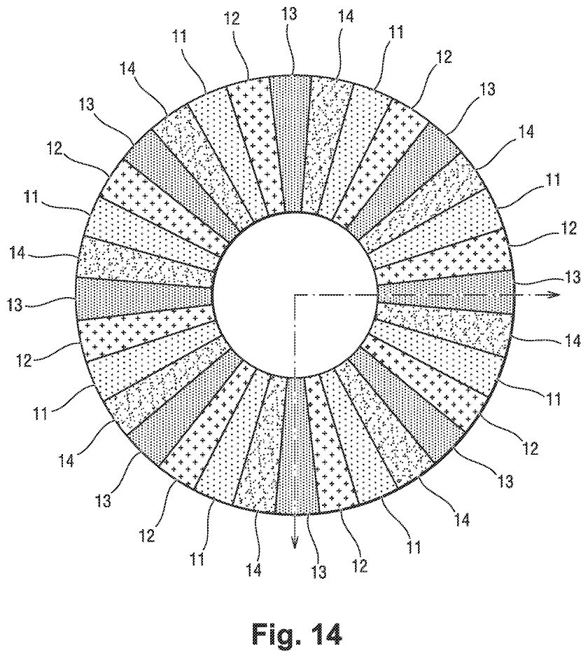

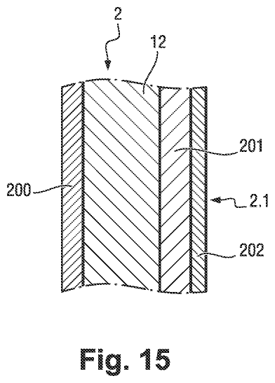

In reference to FIG. 13, the lengths L11, L13 of the magnets 11, 13 are identical to one another and the lengths L12, L14 of the magnets 12, 14 are identical to one another. The lengths L11, L13 of the magnets 11, 13 are greater than the lengths L12, L14 of the magnets 12, 14. Preferably, the length L12, L14 of the second magnets 12, 14 is around 70% of those—L11, L13—of the first magnets 11, 13.

In the arrangement represented in FIG. 13, the magnets 12, 14 are positioned symmetrically on a circle passing through the geometric centre of the North pole of the magnets 11 and South pole of the magnets 13.

It is understood that, in the two embodiments of the stator, the magnets 12, 14 at the same time occupy the main face 2.1, a surface area less than that of the magnets 11, 13.

The arrangement of the magnets 11, 12, 13, 14 makes it possible to optimise and to concentrate the magnetic flux produced by the magnets 11, 13 by reducing the return path of the magnetic flux which passes through the magnets 12, 14, and not through the support, the mass of which can be reduced, since there is no need to ensure a conduction function of the magnetic flux.

The two embodiments above both enable an increase of the braking torque provided while limiting the mass and the bulk of the device. The first embodiment of the stator enables a greater magnetic braking torque than the second embodiment, but however has a greater weight.

Whatever the embodiment of the stator, the magnets 11, 12, 13, 14 have their surface, opposite the support 200, covered with an intermediate layer 201, itself covered with a friction trim 202 having, opposite the intermediate layer 201, a surface forming the face 2.1 of the stator 2.

The intermediate layer 201, inserted between the magnets 11, 12, 13, 14 and said friction trim 202, is made of non-magnetic steel and has a sufficient thickness to enable it to constitute a thermal screen between the friction trim 202 and the magnets 11, 12, 13, 14. The magnets will naturally be chosen to have a limited loss of magnetisation at the temperatures of using the magnetic braking device: in any case, the Curie temperature of the magnets used must be a lot greater than the temperature of using the magnetic braking device, whatever the braking mode used. The intermediate layer 201 also ensures a protection of the magnets against impacts and favours the holding of the magnets on the support 200. The intermediate layer 201 can be screwed, riveted, or welded on the support 200, such that the magnets are preferably confined between the intermediate layer 201 and the support 200.

The friction trims 202 are made of anti-magnetic material (to not create any magnetic short-circuit) and preferably electrically insulating (to limit losses during magnetic braking). The friction trim 202 is, for example, fixed to the intermediate layer 201 by hot-melt bonding or riveting. Such friction trims are known themselves.

Each rotor 1 has a thickness, such that a skin effect (otherwise called pellicular effect or Kelvin effect) is generated from each face 1.1 of the rotor 1 over more than half the thickness of the rotor 1 at least over a range of possible relative speeds of the rotor 1 with respect to the stators 2. The eddy currents generated from the two faces 1.1 will thus circulate in the central part of each rotor 1, which will increase the braking torque. Thus, a “superposition of the skin effects” is obtained, the thickness of the rotor 1 being sufficiently low to obtain this effect, while satisfying the thermal and mechanical stresses. In an example, this effect gives around 60% of performance in addition.

It can be understood that:
to cause the magnetic braking, the control actuator is controlled to bring the stators 2 into an intermediate position between the first position and the second position, intermediate position in which the stators are sufficiently close to the rotors, without touching them, such that the magnets generate, in the rotors, sufficient eddy currents to cause the sought braking of the rotors, and
to interrupt the magnetic braking, the control actuator is controlled to bring the stators 2 into the second position, position in which the stators are sufficiently away from the rotors, such that the magnets do not generate, cause a in the rotors, sufficient eddy currents to significant braking of the rotors.

It will be noted that below a certain rotation speed of the rotors 1, the braking torque is insignificant, whatever the position of the stators. An additional brake must thus optionally be considered.

At these low speeds, or when the aircraft has stopped, the braking device according to the invention can be used to achieve a friction-based braking.

It can be understood that:
to cause the friction-based braking, the control actuator is controlled to bring the stators 2 into the first position (proximate position), position in which the braking surfaces 2.1 are in contact with the braking surfaces 1.1, 1.2 and are held in this position by the magnets 11, 12, 13, 14, even in the absence of powering of the actuator, and
to interrupt the friction-based braking, the control actuator is controlled to bring the stators 2 to the second position, position in which the braking surfaces 1.1, 1.2, 2.1 are no longer in contact with one another.

To ensure that the braking surfaces 2.1 are actually in contact with the braking surfaces 1.1, 1.2 and thus held by magnetic attraction, it can be provided that a slight axial clearance is left between the actuator and the stators when the stators have been brought into their first position.

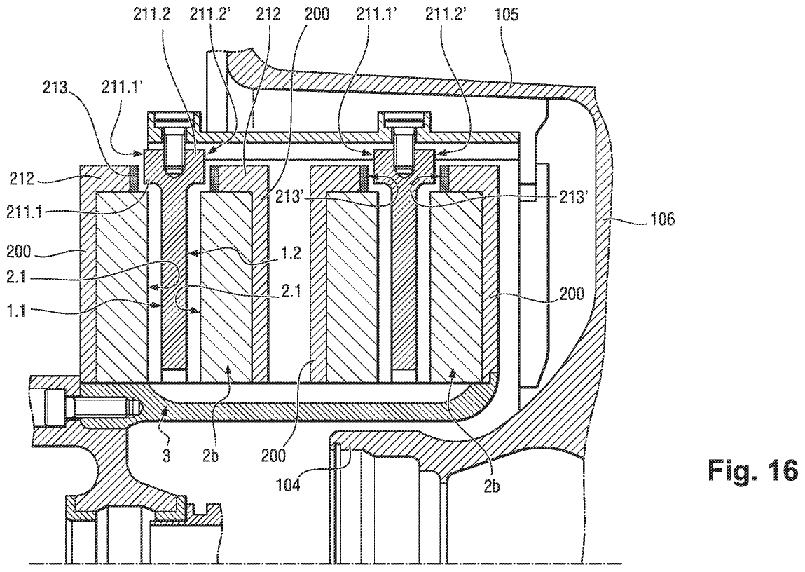

In the following description of the second embodiment, given with reference to FIG. 16, elements that are identical or similar to those described above are given the same reference number.

In this second embodiment, the device comprises first axial abutments joined so as to rotate as one and in translation to the stators N and second axial abutments joined so as to rotate as one and in translation to the rotor 1 to prevent a contact of the faces 2.1 of the stators 2 with the faces 1.1, 1.2 of the rotors 1 when the stators 2 are in their first position.

The axial abutments comprise, in this case, two pairs of rings 211.1, 211.2, each integral with an external perimeter of the rotors 1 and centred on the pivot axis. The ring 211.1 has a flat annular face 211.1′ extending perpendicularly to the pivot axis and in front of the face 1.1 of the rotor 1, with which it is integral to form a braking surface and the ring 211.2 has a flat annular face 211.2′ extending perpendicularly to the pivot axis and in front of the face 1.2 of the rotor 1 with which it is integral. The flat annular faces 211.1′, 211.2′ form braking surfaces.

Each stator 2 also comprises a ring 212 extending from an external perimeter of the support 200 by surrounding the magnets 11, 12, 13, 14. Each ring 212 has a flat annular end face which extends perpendicularly to the pivot axis and is covered by a friction trim 213, the free surface of which forms a braking surface 213′.

It can be understood that, when the stators 2 are in their proximate position, the braking surfaces 213′ are in contact with the braking surfaces 211.1′, 211.2′ providing a friction-based braking. It will be noted that in this position, the faces 1.1, 1.2 are not in contact with the faces 2.1.

For the rest, the operation is identical to that of the first embodiment.

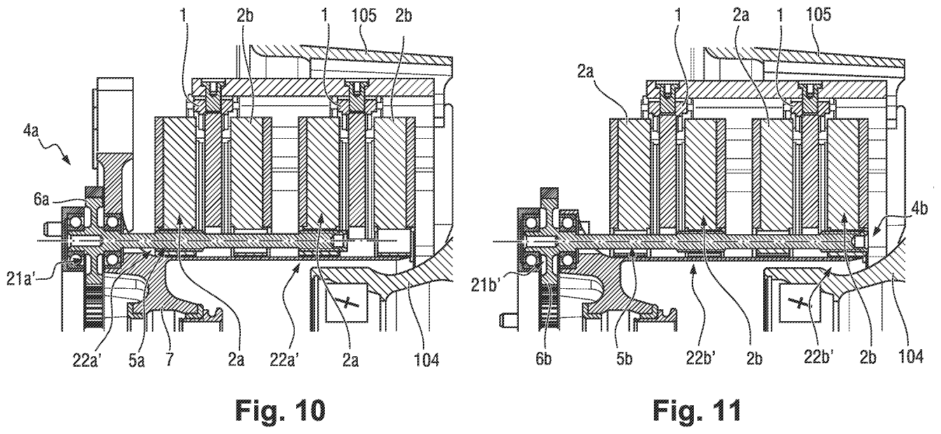

The device of the invention can implement an actuator according to a second embodiment represented in FIGS. 10 and 11.

In the second embodiment of the actuator 4, the actuator 4 comprises, as above, a plurality of transmission assemblies generally referenced as 4a to move the stators 2a and a plurality of transmission assemblies generally referenced as 4b to move the stators 2b. The transmission assemblies 4a are alternately placed with respect to the transmission assemblies 4b.

Each transmission assembly 4a comprises an operating bar 5a mounted on the twisting tube 3 to extend parallel to the primary rotary axis 107 and pivot without sliding about said axis.

The operating bar 5a is connected by a first mechanical connecting member 21a′ to a pinion 6a mounted in the actuator carrier plate 7 by rollers to be stationary in translation and movable so as to rotate about a secondary rotary axis 6a′ colinear to the longitudinal axis of the operating bar 5a. The first mechanical connecting member 21a′ ensures an installation connection of the end of the operating bar 5a in the pinion 6a. The first mechanical connecting member 21a′ can be a welding, adhesive, an interlocking, a clamped adjustment, a bolt, a pin, etc. In this case, the operating bar 5a, the first mechanical connecting member 21a′ and the pinion 6a are made of one single part. Thus, a rotation of the pinion 6a causes a rotation of the operating bar 5a in one direction or in the other, in the rotary direction of the pinion 6a. The pinions 6a mesh with an internal gearing of a ring which is centred on the primary rotary axis 107 and which surrounds the pinions 6a. This ring is identical to the ring 8 and is mounted and rotated like the latter.

The operating bar 5a is connected by a second mechanical connecting member 22a′ to each stator 2a. Each second mechanical connecting member 22a′ comprises a mesh extending around the operating bar 5a and engaging with a tapping provided in the internal circumference of the stator 2a. The two second mechanical connecting members 22a′ ensure a helical connection between the operating bar 5a and the stators 2a.

Each transmission assembly 4b comprises an operating bar 5b mounted on the twisting tube 3 to extend parallel to the primary rotary axis 107 and pivot without sliding about said axis.

The operating bar 5b is connected by a first mechanical connecting member 21b′ to a pinion 6b mounted in the actuator carrier plate 7 by rollers to be stationary in translation and movable so as to rotate about a secondary rotary axis 6b′ colinear to the longitudinal axis of the operating bar 5b. The first mechanical connecting member 21b′ ensures an installation connection of the end of the operating bar 5b in the pinion 6b. The first mechanical connecting member can be a welding, adhesive, an interlocking, a clamped adjustment, a bolt, a pin, etc. In this case, the operating bar 5b is made of one single part with the pinion 6b. Thus, a rotation of the pinion 6b causes a rotation of the operating bar 5b in one direction or in the other, in the rotary direction of the pinion 6b. The pinions 6b mesh with an internal gearing of the abovementioned ring which surrounds the pinions 6a.

The operating bar 5b is connected by a second mechanical connecting member 22b′ to each stator 2b. Each second mechanical connecting member 22b′ comprises a mesh extending around the operating bar 5b and engaging with a tapping provided in the internal circumference of the stator 2b. The two second mechanical connecting members 22b′ ensure a helical connection between the operating bar 5a and the stators 2b.

The helical connections formed between the stators 2b and each operating bar 5b are of direction opposite the helical connection formed between the stators 2a and each operating bar 5a. It can be understood that when the ring rotates in one direction, it drives the pinions 6a, 6b and the operating bars 5a, 5b in the same direction; however, the stators 2a move in a direction opposite the direction of movement of the stators 2b. A rotation of the ring in a first direction therefore causes a proximation of the stators 2a with the stators 2b respectively (the air gap with the rotors 1 decreases) while a rotation of the ring in a second direction causes an extension of the stators 2a with the stators 2b respectively (the air gap with the rotors 1 increases).

Naturally, the invention is not limited to the described embodiments, but covers any variant coming within the scope of the invention such as defined by the claims.

In particular, the device can have a structure different from that described.

The magnets can be born by the rotor instead of the stator, two rotors flanking a stator.

The shape, the arrangement and the dimensions of the magnets can be different from those described. For example, and according to the third embodiment represented in FIG. 14, the magnets 11, 12, 13, 14 all have the same dimensions. Preferably, the first magnets 11, 13 will represent around 70% of the surface of the element which bears them, but this is not compulsory.

It is advantageous, but not compulsory, to have an arrangement of magnets according to which the plurality of magnets comprises first magnets 11, 13 and second magnets 12, 14 placed alternately, the first magnets 11, 13 having a first magnetisation vector substantially perpendicular to the surfaces opposite 1.1, 1.2, 2.1 and each of the second magnets 12, 14 having a second magnetisation vector substantially perpendicular to the first magnetisation vectors of the two first magnets between which it is located; and the magnets 11, 12, 13, 14 have widths such that the first magnets 11, 13 are spaced apart in pairs by a first distance less than a second distance separating the second magnets 12, 14 in pairs.

The use of a Halbach array is not compulsory.

The number of rotors and/or the number of stators can be different from those mentioned.

The actuator can have a structure different from that described. Thus, each of the stators can be mounted on a sliding slider (without rotation) on the twisting tube to be movable in an axial direction of the twisting tube between a first position in which the rotor and the stator are in contact with one another, and a second position in which the rotor 3 and the stator 2 are separated from one another. At least one electromechanical actuator, controllable by the pilot of the aeroplane in a manner known per se, moves the slider between the two abovementioned positions. It can be understood that to cause the friction-based braking, the electromechanical control actuators are controlled to bring the stators into the first position, and that, to interrupt the friction-based braking, the electromechanical control actuators are controlled to bring the stators into the second position.

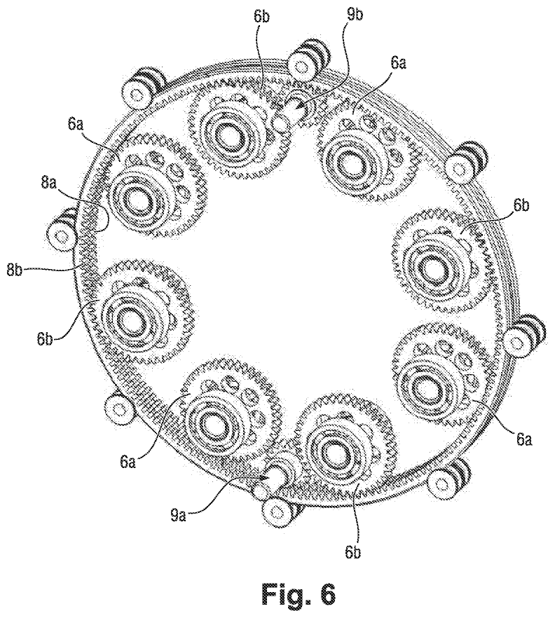

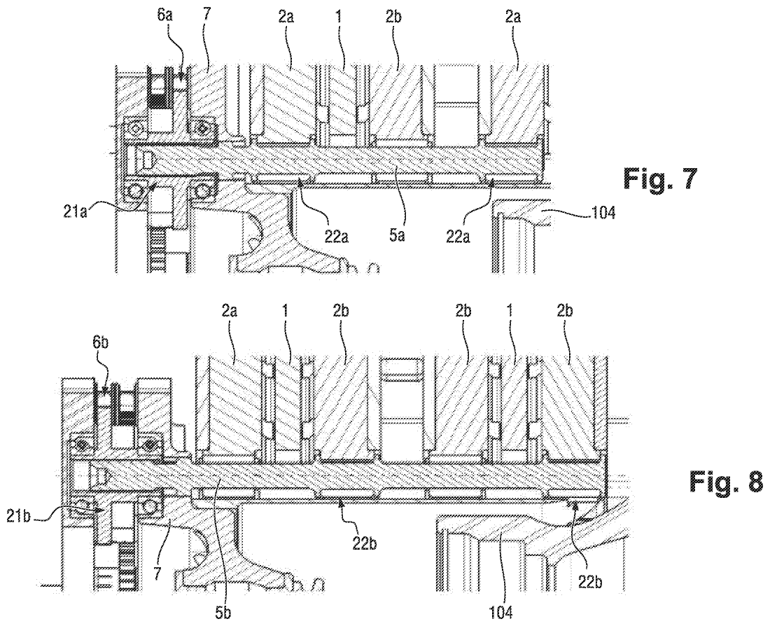

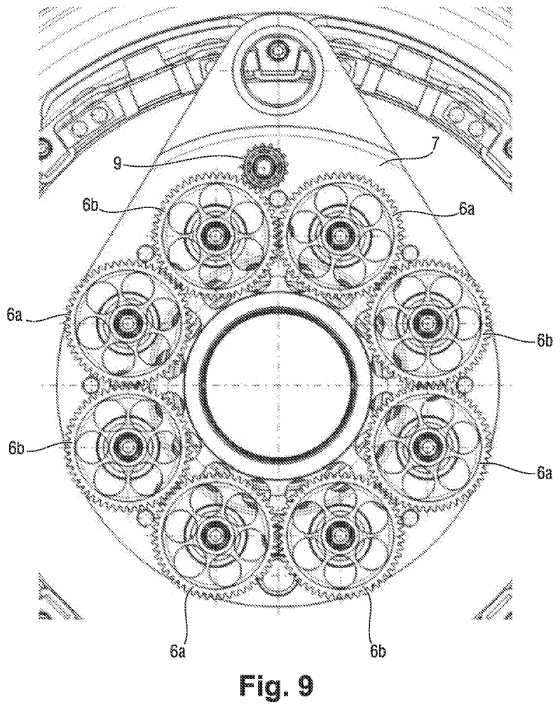

The actuator according to the first embodiment can be modified. Thus, in the variant of FIGS. 6 to 8, the pinions 6a are connected to the operating bars 5a by a helical connection of the same direction as that connecting the pinions 6b to the operating bars 5b. The pinions 6a mesh with the inner gearing of a ring 8a rotated by a pinion 9a while the pinions 6b mesh with the inner gearing of a ring 8b rotated by a pinion 9b. The ring 8b is superposed to the ring 8a which is the ring closest to the braking clearances A, B. The pinions 8a are therefore closer to the stators 2al than the pinions 8b. It can be understood that, in this variant, the engine pinions 9a, 9b drive the rings 8a, 8b in first opposite directions to move respectively each stator 2a closer to the rotor 1 and each stator 2b to the rotor 1 and in second opposite directions to respectively separate each stator 2a from the rotor 1 and each stator 2b from the rotor 1. In the variant of FIG. 9, the ring 8 is removed. The adjacent pinions 6a, 6b mesh with one another in pairs. An engine pinion 9 meshes with one of the pinions 6b such that the motion that the engine pinion 9 communicates to said one of the pinions 6b is communicated step by step to the other pinions 6a, 6b. As a pinion 6b is placed between each pair of pinions 6a, all the pinions 6b rotate in the same direction which is opposite the direction in which the pinions 6a rotate. Thus, in a first rotary direction of the engine pinion 9, the pinions 6a, 6b move the operating bars 5a, 5b to move respectively each stator 2a closer to the rotor 1 and each stator 2b to the rotor 1b and, in a second rotary direction of the engine pinion 9, the pinions 6a, 6b move the operating bars 5a, 5b to separate each stator 2a from the rotor 1 and each stator 2b from the rotor 1.

The actuator according to the second embodiment can also itself be modified. It is possible to have on one same operating bar, helical connections of opposite directions, for example, by returning threaded sleeves externally on the operating bar. The same operating bar can thus move the two stators of the same clearance.

The magnetic braking device according to the invention can be associated with a conventional friction-based braking device which comprises friction members, for example a carbon disc stack, and a plurality of electromechanical actuators born by an actuator carrier. Each electromechanical actuator comprises an electric motor and a pushbutton able to be moved by the electric motor to press the disc stack. The electromechanical actuator is thus intended to produce a braking force controlled on the disc stack. A mode for controlling the braking devices is, for example, known from document FR-A-2953196.

The axial abutments can have a structure different from that described. The axial abutments joined so as to rotate as one and in axial translation to the rotor can, for example, be separated from the rotors and fixed directly to the rim.

1. A landing gear comprising:
a strut having an end bearing a shaft on which the hub of a wheel is mounted, provided with an eddy-current-based magnetic braking device comprising two external elements flanking a central element that is aligned on a same axis with the two external elements and that rotates about said axis with respect to the two external elements, the two external elements having first faces facing second opposite faces of the central element and each bearing a plurality of magnets able to emit, via the first faces, a magnetic flux engendering eddy currents in the central element, made of electrically conductive material, when the two external elements and the central element are in relative motion,
wherein the plurality of magnets are placed so as to generate a magnetic attraction between the two external elements, in that first friction-based braking surfaces are joined so as to rotate as one to the two external elements and second friction-based braking surfaces are joined so as to rotate as one to the central element, and in that the two external elements are movable with respect to the axis between a proximate position of the central element in which the first braking surfaces are held applied against the second braking surfaces by magnetic attraction and a separated position of the central element in which the first braking surfaces are separated from the second braking surfaces, and
the eddy-current-based magnetic braking device comprises first axial abutments joined so as to rotate as one and in axial translation to the two external elements and second axial abutments joined so as to rotate and in axial translation to the central element to prevent a contact of the first faces with the second faces when the external elements are in the proximate position,
the first braking surfaces are arranged on the first abutments and the second braking surfaces are arranged on the second abutments,
each first abutment comprising a ring, centered on the pivot axis, extending from an external perimeter of one of the external elements projecting from the magnets and having a flat annular end face which extends perpendicularly to the pivot axis to form one of the first braking surfaces, and
each second abutment comprising a ring, centered on the pivot axis, extending from an external perimeter of one of the second faces of the central element and having a flat annular end face which extends perpendicularly to the pivot axis to form one of the second braking surfaces.

2-5. (canceled)

6. The landing gear according to claim 1, in which the first braking surfaces comprise a friction trim made of electrically insulating material.
